(19) United States
(12) Patent Application Publication
(10) Pub. No.: US 2026/0077793 A1
(43) Pub. Date: Mar. 19, 2026

(54) Lug Cart Bin Securing System with Tool-Free Stop Mechanisms

(71) Applicant: Iain Milnes, Fremont, CA (US)

(72) Inventor: Iain Milnes, Fremont, CA (US)

(21) Appl. No.: 18/886,743

(22) Filed: Sep. 16, 2024

(51) Int. Cl. B62B 3/00; B62B 3/04

(52) U.S. Cl. CPC B62B 3/005; B62B 3/04; B62B 2202/12

(57) ABSTRACT

A method is disclosed for securing bins in a lug cart by providing a lug cart with a frame supported on wheels and horizontal rails on the frame for supporting bins; installing a stop mechanism on at least one end of the lug cart, the stop mechanism comprising a locking rod and at least one locking rod bracket; engaging the stop mechanism without tools to prevent bins from exiting the lug cart; and disengaging the stop mechanism without tools to allow removal of bins from the lug cart.

### BACKGROUND OF THE INVENTION

The present invention relates to a bin securing system.

The warehousing, manufacturing, food service, and retail industries frequently face challenges related to the efficient and secure transport of goods or waste within facilities. A common solution is the use of lug carts, which are designed to carry bins or totes filled with materials or products.

A lug cart is a frame that is usually supported on four wheels. The frame can accommodate bins that slide in and out on horizontal rails of the frame. Usually, these bins are arranged vertically, so there may be three to six bins or more, and this will make a frame that typically may be from 1100 mm to 1800 mm tall. Some lug carts may be constructed with two or more vertical columns of bins, for example with three or more bins in each column. This would make the lug cart wider but lower in height than a lug cart with the same number of bins vertically arranged.

The majority of lug carts on the market today permit the bin to be inserted from either side of the cart. This is convenient, but the bin may fall off its rail unintentionally, possibly causing a mess as the contents of the bin spill, damage to surrounding areas, and injury to operators or other personnel nearby. In particular, when a lug cart is used on a ship, as the ship rocks, it is likely that the bin may become dislodged.

Traditionally, these carts require tools for attaching and securing the bins, which can be time-consuming and may necessitate additional labor or training. Furthermore, the use of tools can result in the loss or breakage of securing hardware, leading to delays and potential safety hazards if bins become unsecured during transit.

Additionally, the lack of flexibility in the positioning of bins can limit the effectiveness of space utilization, particularly in dynamic environments where the size and number of bins required may vary significantly. These issues underscore the need for an innovative system that addresses the challenges of flexibility, safety, and efficiency in the securing of bins on lug carts.

### SUMMARY OF THE INVENTION

In one aspect, a method is disclosed for securing bins in a lug cart by providing a lug cart with a frame supported on wheels and horizontal rails on the frame for supporting bins; installing a stop mechanism on at least one end of the lug cart, the stop mechanism comprising a locking rod and at least one locking rod bracket; engaging the stop mechanism without tools to prevent bins from exiting the lug cart; and disengaging the stop mechanism without tools to allow removal of bins from the lug cart.

In another aspect, a tool-free stop mechanism with a locking rod and bracket is installed on the cart's end. Bins are prevented from exiting the cart by the engagement of the stop mechanism, which is easily disengaged for bin removal. Additionally, the stop mechanism is operated by lifting and turning the locking rod into a selected slot on the bracket.

In implementations, the rotation of the locking rod involves twisting it approximately 270 degrees. The locking rod is designed with a bent section that allows it to effectively engage with the slots present in the locking rod bracket.

Advantages of one implementation may include one or more of the following:
i. Enhanced Efficiency: The method provides quick and easy securing and releasing of bins without the need for tools, thus significantly reducing the time and labor required for loading and unloading materials. This can lead to increased workflow efficiency and productivity.
ii. Improved Safety: The tool-free stop mechanism ensures that bins are securely fastened to the lug cart, reducing the risk of bins falling and causing injury or damage. The presence of a locking rod and bracket system minimizes the need for loose hardware that could create trip hazards or get misplaced.
iii. Adaptability: One implementation allows for flexibility in the positioning of bins within the cart. This is particularly valuable in dynamic environments where the quantity and size of bins being transported can vary frequently.
iv. Cost Savings: By eliminating the need for additional securing hardware or tools, one implementation helps in reducing the costs associated with the purchase, replacement, and maintenance of such equipment.
v. Space Utilization: The optimized design of the stop mechanism allows for better use of the available space on the cart, thus maximizing the number of bins that can be accommodated at any given time.
vi. Simplified Design: The locking rod with a bent section makes engaging the slots easier and more intuitive, thereby simplifying the design and potentially reducing the complexity and cost of manufacturing.
vii. User Friendliness: The ease with which the stop mechanism can be operated makes it more user-friendly, requiring minimal training or expertise for personnel who handle lug carts.
viii. Durability: By reducing the dependency on tools and hardware that may break or get lost, the overall durability and reliability of the lug cart is enhanced, resulting in less frequent need for repair or replacement.
ix. Versatility: One implementation can be implemented across various industries that utilize lug carts, making it a versatile solution that can be adapted to different operational needs and environments.
x. Reduced operational interruptions: With the tool-free stop mechanism, there's less likelihood of operational delays due to missing tools or broken hardware, leading to uninterrupted service and better response times in material handling.

Overall, one implementation offers a practical improvement to conventional lug carts, addressing common challenges in the warehousing, manufacturing, food service, and retail industries with respect to the transport and handling of goods or waste.

### DETAILED DESCRIPTION OF DRAWINGS

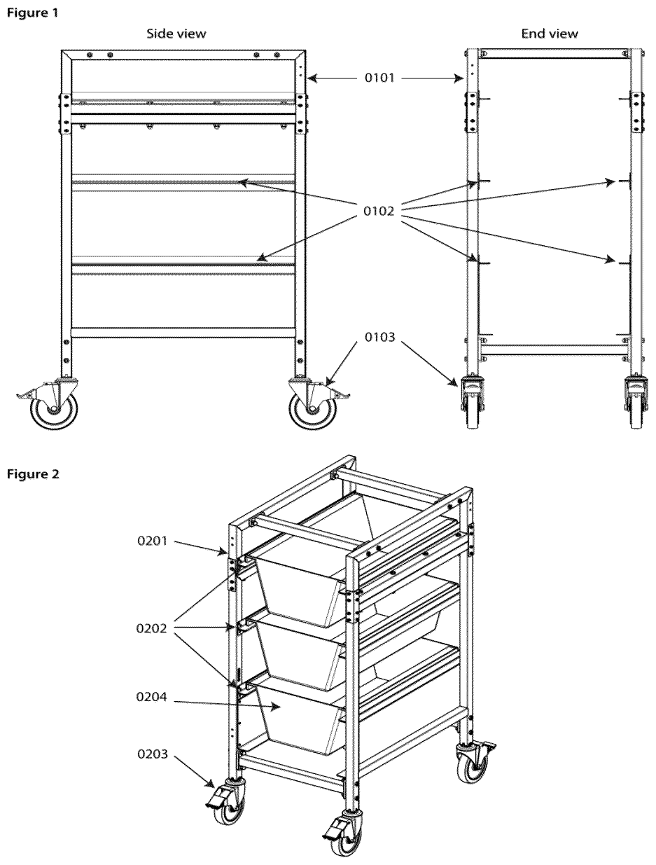

FIGS. 1-2 show a typical lug cart with a plurality of bins.

FIG. 3 shows an exemplary lug cart 1 with one stop mechanism.

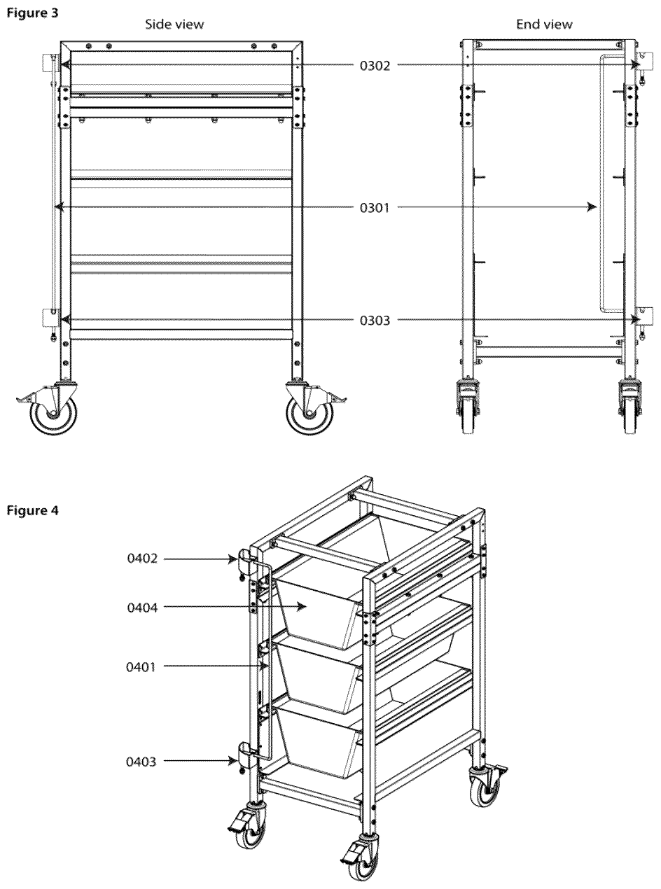

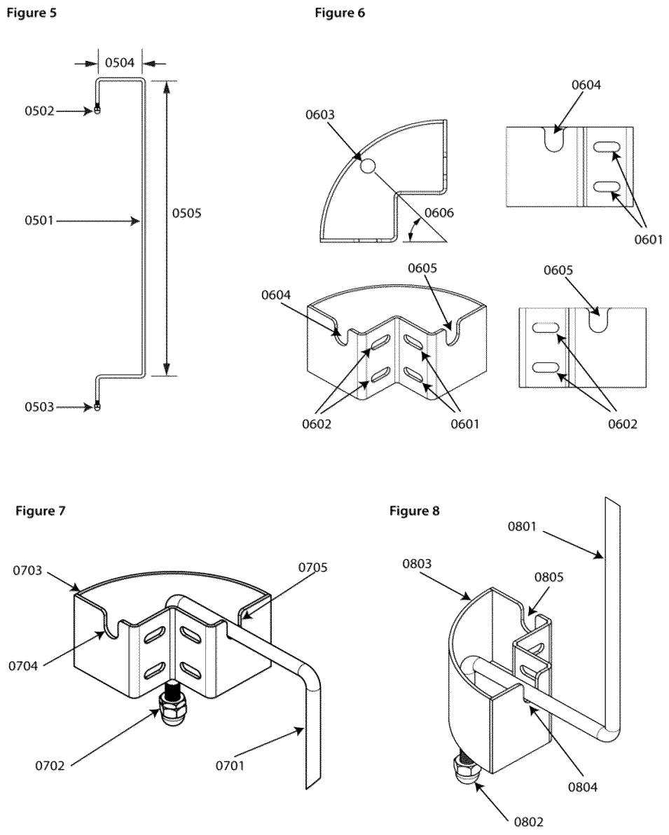

FIGS. 4-5 show an exemplary locking rod FIG. 6 shows one method for creating the locking rod bracket. FIG. 7 shows how the locking rod is fitted into the locking rod bracket when the bracket is installed at the top of the locking rod.

FIG. 8 shows that the same locking rod bracket may be used at the top and at the bottom of the locking rod.

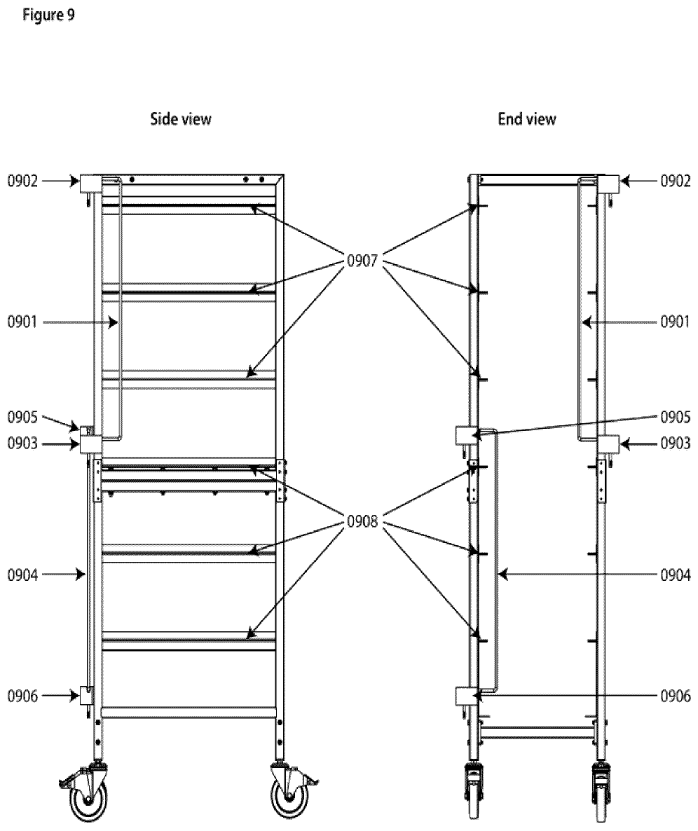

FIG. 9 shows an exemplary lug cart that can hold six bins and that uses two locking rods.

### DETAILED DESCRIPTION OF THE INVENTION

FIG. 1 shows a typical lug cart. The lug cart that is shown has the capacity for only three bins, but lug carts may carry more or fewer bins in a variety of designs. The frame 0101 is mounted on casters 0103. The rails 0102 support the bins. Rails are at the same height on both the left and right side of the frame to support the bins. Generally, the lips of the bins are supported by the rails, but it can be imagined that the rails are platforms and that the bottom of the bins slide on the platform.

FIG. 2 shows a typical lug cart in which the frame 0201 corresponds to 0101, the rails 0202 correspond to 0102, and the casters 0203 correspond to 0103. It also shows three bins 0204 installed in the lug cart.

FIG. 3 shows the lug cart of FIG. 1 with one stop mechanism installed. The locking rod 0301 is retained by the upper locking rod bracket 0302 and the lower locking rod bracket 0303. The locking rod is shown in its engaged position which will prevent the bins from exiting from that side where the stop mechanism is engaged.

FIG. 4 shows the locking rod 0401 and the upper and lower locking rod brackets 0402 and 0403. The locking rod is in the locked position and prevents the bins 0404 from exiting at the end. The system of FIGS. 3-4 reliably secures bins on a lug cart using a stop mechanism that prevents accidental dislodging during movement and storage. The system, which involves no tools for operation, includes a locking rod with a bent portion for proper alignment and easy engagement with the locking rod brackets. The locking rod fits into multiple slots on the brackets for secure positioning and can also be locked further with a retaining mechanism. Moreover, the brackets are designed with mounting slots for straightforward installation, accommodating various sizes and capacities of bins. The method takes into account the potential environmental challenges and is flexible enough to work from either side of the cart, thanks to the symmetrical design of the brackets. This implementation delivers a convenient and adaptable approach to ensuring the safe transport of bins within a lug cart.

FIG. 5 shows the shape of the locking rod. The locking rod 0501 will usually be made of round steel, bent into shape, but may be formed in different materials and constructed differently. The locking rod has one or two retaining nuts shown as 0502 and 0503. These nuts prevent the locking rod from coming out of the locking rod bracket. Whilst nuts are the easiest way to retain the locking rod other ways of preventing the locking from coming out of the locking rod bracket can be envisaged, including adding a cotter pin through a hole at the end of the rod, or simply bending the locking rod at the end.

The distance 0504 is that which is required to retain the bins in the cart. Usually, this will be the minimum distance required to achieve its function, but a longer distance may be envisioned. However, as the distance becomes longer, the locking rod may need to be thicker to withstand the forces imposed on the locking rod by the movement of the bins. The structure of the locking rod can be reinforced or restructured to accommodate any bin, which is not just limited to bin 0204 but any bins with a similar structure or shape. The distance 0505 is that which is required to retain the required number of bins. It will be smaller for one bin than for multiple bins.

FIG. 6 shows one method for creating the locking rod bracket. The Fig. shows x, y, and z views plus a 3D view. This example of the locking rod bracket is separate from the frame of the cart and can be bolted to the frame of the cart. However, different arrangements can be made to integrate the locking rod bracket to the frame of the cart, including welding or gluing the locking rod bracket to the frame of the cart.

The slots 0601 and 0602 are used to bolt the locking rod bracket to the frame of the cart. However, it may be possible to have holes instead of slots and it may be possible to accommodate a single bolt or multiple bolts in a different arrangement.

The locking rod will pass through hole 0603 and it can be rotated to fall into slot 0604 or slot 0605. Depending where the locking rod bracket is mounted, the locking rod will be in slot 0604 or 0605 to block the bins and in slot 0605 or 0604 to allow free movement of the bins. The depth of the slots 0604 and 0605 can be varied depending upon the diameter of the rod, the retaining force necessary to prevent the sliding of the bins, and the shape of the rod.

It is advantageous to design the locking rod bracket to be symmetrical, so that the same locking rod bracket can be used on the front end or the back end of the frame of the cart and can be used on the right side or left side of the frame of the cart. However, if this is not desired, the symmetry may be unnecessary. If the locking rod bracket is symmetrical, then the angle 0606 is 45°.

FIG. 7 shows how the locking rod 0701 is fitted into the locking rod bracket 0703 when that bracket is installed at the top of the locking rod. Once the locking rod is installed, the nut 0702 is installed, but as described earlier, other mechanisms for holding the locking rod in place may be used. Under its own weight, the locking rod is fitted into slot 0705. However, it may be envisaged that a spring is installed between the bottom of the locking rod bracket 0703 and the nut 0702 to assist in keeping the locking rod down in the slot. To move the locking rod to slot 0704, the operator will raise the locking rod and rotate it through 270°. The nut 0702 prevents the locking rod from coming out of the locking rod bracket. If the locking rod is not symmetrical, the angle that the rod needs to be rotated may be different from 270°. If the slot 0705 is where the locking rod is positioned to retain the bin, then the slot 0704 will be where the locking rod is positioned to allow the bin to move. Conversely, if the slot 0704 is where the locking rod is positioned to retain the bin, then the slot 0705 will be where the locking rod is positioned to allow the bin to move.

FIG. 8 shows that the same locking rod bracket 0803 may be used at the top and at the bottom of the locking rod 0801. If the locking rod length 0505 is short, then it may be possible to have a simplified bracket at one end of the locking rod, with, for example, just hole 0603. However, for better physical integrity, using the same locking rod bracket at both the top and bottom of the locking rod is advised. FIG. 8 shows a nut 0802 fitted to the bottom of the locking rod. Only one mechanism for retaining the locking rod is required, but again, having a retaining mechanism at both the top and bottom of the locking rod provides better mechanical integrity. When the locking rod 0701 =0801 is moved, it will be in slots 0705 and 0805 or in slots 0704 and 0804.

FIG. 9 shows a lug cart that can hold six bins and that uses two locking rods. As explained earlier, it may be possible to have a single locking rod for all six bins; however, this would require the locking rod to be thick to obtain the strength necessary to hold the bins in the middle of the length of the locking rod. Also, this method of using more than one locking rod may apply to any cart that has more than one bin. The locking rod 0901 is retained by locking rod brackets 0902 and 0903. The locking rod 0904 is retained by locking rod brackets 0905 and 0906. In the End view of FIG. 9, the locking rods are shown in the position that would prevent the bins from sliding out and the locking rods can be moved separately. The locking rod 0901 will retain the bins that may be placed in the rails 0907. The locking rod 0904 will retain the bins that may be placed in the rails 0908.

The lug cart's frame is mobilized by caster wheels, ensuring ease of maneuverability. The lug cart further comprises horizontal rails that are designed to support bins. A distinguishing feature of the lug cart is the incorporation of a tool-free stop mechanism, which consists of a locking rod and a bracket. This mechanism is fitted at the corner of the cart. The stop mechanism is primarily responsible for precluding bins from inadvertently sliding out of the lug cart. It achieves this by enabling the locking rod to interact with the locking rod bracket such that, when a bin is placed into the cart, the locking rod can be lifted and rotated for insertion into a corresponding slot of the locking rod bracket, thus securing the bin in place. To release a bin, the mechanism requires a simple reverse action—lifting and twisting the locking rod out of the slot, which allows for the prompt removal of the bin.

By implementing such a stop mechanism, the lug cart provides a more efficient process for both securing and releasing bins due to the negation of tools for operation. This feature is not only time-saving but also reduces the physical labor conventionally associated with the loading and unloading of materials or waste. As a result, it plays a significant role in augmenting workflow efficiency and overall productivity. Moreover, safety considerations are duly addressed; the securement of bins diminishes the likelihood of accidental falls that could result in injury or damage. The locking rod and locking rod bracket system confers an additional safety layer by eliminating the necessity for additional, potentially hazardous loose hardware.

The tool-free stop mechanism's strategic design facilitates immediate operational alteration of the cart's bin retention capability, obviating the necessity for external implements which might otherwise be misplaced or pose the risk of being trip hazards. By streamlining the loading and unloading process, this innovative feature inherently advances the overall efficiency of material handling. Furthermore, the reliability of the stop mechanism in maintaining the bins in a fixed state during transit or stationary periods significantly raises the safety standard by diminishing the probability of bins inadvertently sliding or tipping, which could result in potential injury to personnel or damage to the content of the bins or surroundings.

The tool-free stop mechanisms are configured to allow users to independently engage or disengage each stop mechanism as needed. This provides the advantage of selective access from either end of the lug cart, thereby enhancing its functionality and ease of use.

When the stop mechanisms are in the engaged state, they prevent any movement of the bin, which is particularly important when the cart is positioned on an inclined surface or when precision is crucial during loading and unloading of items. Conversely, when the stop mechanisms are disengaged, the bins can be freely moved to different locations, thereby improving efficiency and reducing the physical strain on users.

Notably, the design of the stop mechanism is such that it accommodates a variety of bin sizes and shapes by providing adjustable points of engagement. These adjustable points allow the mechanism to securely hold each bin regardless of its individual specifications, ensuring that the solutions provided by the lug cart are not limited by the dimensions of the cargo it carries.

Furthermore, the stop mechanism's ease of use does not compromise its robustness or durability. It is constructed from materials that are capable of withstanding the wear and stresses that come from regular use in a demanding environment. Its durability ensures that the stop mechanism remains fully operational over the long term, withstanding the corrosive atmospheres as well as the mechanical stresses imposed by frequent movement on slopes.

The utility offered by the stop mechanism is complemented by its minimal impact on the overall design of the lug cart. It maintains the cart's aesthetic appeal while simultaneously offering functional benefits. The mechanism is compact, allowing for the seamless operation of the lug cart without adding unnecessary bulk or complexity to the cart's design.

In one embodiment, the assembly features a locking rod which is typically a cylindrical element that can be manipulated to engage or disengage with the brackets. The locking rod is turned through an arc of approximately 270 degrees. This significant rotation ensures that the locking rod moves from a first position, which may be characterized as an unlocked or release state, to a second position, which acts as a secure or locked state, or vice versa. The arc of 270 degrees is chosen to provide an adequate range of motion that ensures the locking rod engages with or disengages from the corresponding locking or engagement features with sufficient movement to establish a robust and reliable locking action.

The implementation of a 270-degree turn allows for a distinct and tangible indication to the user that the action required to secure or release the mechanism has been completed. With this range of rotation, the locking rod is likely to interface with several structural elements that may include grooves, notches, or similar features within the mating components of the assembly. This configuration is intentionally designed so that when the locking rod is in the locked position, it mechanically interlocks with the engagement features, thus preventing unintended movement, disengagement, or slippage that might otherwise occur under conditions of use.

Such a method of engagement using a locking rod that necessitates a considerable degree of rotation is particularly advantageous in applications where a secure fit is crucial and where it can provide a readily discernible physical confirmation of the locking status to the user. It can be employed in a wide range of applications including, but not limited to, securing components of machinery, fastening parts of furniture, or in systems where quick and reliable locking and unlocking mechanisms are essential for operation or user safety. The selected degree of rotation may also be optimized based on ergonomic considerations for the user, the space constraints within the device, and the desired ease or security of the locking action.

The rotation of 270° minimizes the size and interference of the locking rod. When the locking rod is engaged, it is parallel to the end of the lug cart and therefore contributes only minimally to the depth of the lug cart. When the locking rod is disengaged, it is parallel to the side of the lug cart and therefore contributes only minimally to the width of the lug cart. The fact that the locking rod is flush to the side or end of the lug cart also makes it less likely to snag on any object as the lug cart is being moved.

The locking rod is characterized by a specially designed bent portion. This bent portion is not merely a structural feature but is conceived for a specific functional engagement with corresponding slots present in the locking rod brackets.

Another embodiment features a second locking rod bracket that is rigidly mounted on the frame. The locking rod extends through this second locking rod bracket as well as a first locking rod bracket. This configuration ensures that when the locking rod is engaged, it passes through both brackets, effectively increasing the stability and rigidity of the overall structure.

When inserted through both the first and second locking rod brackets, the locking rod acts as a barrier that prevents the movement of certain components, such as shelves, bins, or other structural elements that may be part of the frame assembly. To unlock the mechanism and allow for adjustment or removal of those components, the locking rod can be retracted so that it no longer passes through the brackets, granting the user the ability to reconfigure the setup as needed.

The second locking rod bracket functions cooperatively with the first locking rod bracket to provide a secure hold, thus preventing unintended movement or disengagement of the components that are being locked. This is particularly advantageous in environments where the assembly may be subject to vibration or movement, as the dual-bracket system offers a redundant safety mechanism, ensuring that the locking rod remains in place even if one of the brackets were to fail or become loose.

This dual-bracket locking system is designed for ease of use and can often be operated without the need for tools. For example, the locking rod may feature an ergonomic handle or knob that allows for hand operation, thereby eliminating the necessity of tools for locking or unlocking. This feature is particularly useful for users who may need to make quick adjustments to the configuration of the assembly.

One implementation can include a method for determining an optimal number of bins to be secured by a single stop mechanism. This determination can be based on factors such as the size and weight of the bins, the contents of the bins, the dimensions of the shelves on which the bins will be placed, and the overall design of the storage system. The optimal number of bins is the quantity that the stop mechanism can securely hold in place without risk of failure or compromise to the integrity of the storage system. This determination can be achieved by calculation, simulation, or empirical testing.

Once the optimal number of bins is determined, the locking rod is designed to have the necessary length and strength to secure the optimal number of bins. The length of the locking rod is critical, as it must span the required distance across the bins when they are placed on the frame. The strength of the locking rod is equally important, as it must withstand the collective force that the bins and their contents may impose during unexpected movement. The locking rod can be fabricated from materials such as metal, composite, or any suitable material that meets the criteria of the strength and durability required.

A central hole is precisely machined through the body of the bracket to accommodate the locking rod. This hole is of a diameter that is slightly larger than that of the locking rod to ensure a smooth passage while maintaining a close fit to maximize stability and minimize any unwanted lateral movement.

The locations and angles of slots have been optimized to ensure that when the locking rod is inserted and engaged within any of these slots, the resulting interaction provides a secure lock that resists unintentional disengagement. The engagement is such that when the locking rod is in place, the transfer of force through the bracket is balanced, ensuring that the locking mechanism can withstand significant loads without compromising the integrity of the engagement.

One embodiment further comprises a feature wherein the locking rod is secured with a retaining mechanism to prevent it from disengaging from the locking rod bracket. This retaining mechanism is crucial for maintaining the structural integrity and functionality of the locking system. The locking rod, which plays a crucial role in the assembly by engaging with and disengaging from the locking rod brackets, ensures that the components held together by the locking system are firmly secured in place.

The retaining mechanism is positioned in such a way on the locking rod that it allows the rod to perform its function by moving into and out of the locking position as necessary. However, when the locking rod is in the engaged position, the retaining mechanism ensures that the locking rod cannot become dislodged due to vibrations, force, or movement of the components that it serves to secure.

This added feature not only enhances the reliability of the lock but also provides for the possibility of quick release and secure re-engagement of the locking rod. This can be advantageous in environments where frequent adjustments, maintenance, or assembly and disassembly are required, as it allows for easy access without compromising security or stability when the locking system is engaged.

Inclusion of such a retaining mechanism allows for a diverse range of applications and can be tailored to fit various locking rod sizes and shapes, as well as to accommodate different levels of retention force, depending on the specific needs of the application. The choice of material and design for the retaining mechanism may also vary based on the environmental conditions and the physical stresses to which the locking system will be subjected, thus allowing for enhanced durability and longevity.

In certain embodiments, the retaining mechanism comprises a nut that is threaded onto the locking rod. The locking rod is configured to securely engage with the shelf brackets to maintain the position of the shelves at a desired height within the frame. The nut can be rotated along the threads of the locking rod to advance towards the frame, thereby applying pressure against the shelf brackets to restrain movement. This configuration allows for adjustable shelving, wherein the shelves can be repositioned by loosening the nut, moving the locking rod and the attached shelf to a new position, and subsequently tightening the nut to secure the shelf in place.

A user may perform adjustments without the need for tools due to the tool-free stop mechanism which may feature an intuitive design allowing for manual loosening and tightening of the nut. Furthermore, the locking rod may include a series of indentations or grooves along its length to provide tactile feedback during adjustments, indicating the new position before the nut is tightened. The retaining mechanism ensures that the shelves remain stable and secure when subjected to the loads associated with typical usage.

The assembly may feature a modular design, wherein additional securing bins can be attached to the frame providing further organizational capabilities. The securing bins could be connected to the frame using complementary engagement features such as clips, hooks, or magnetic attachments, facilitating easy installation and removal as needed.

This combination of elements constitutes an adaptable storage solution with a balance of mobility and stability, enabling the user to customize the shelving based on personal preference or spatial requirements. The incorporation of a threaded nut as a retaining mechanism on a locking rod represents a straightforward and efficient means of adjusting and securing the positional arrangement of shelves within the overall structure.

Although the present invention applies to any moving object that holds bins, tubs, or trays, the term “lug cart” is used throughout this patent and the term “bins” should be interpreted to mean bins, tubs, or trays. That is, this patent is not limited solely to lug carts which carry bins as those terms are generally used.

Particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention.

The above detailed description of the embodiments of the invention is not intended to be exhaustive or to limit the invention to the precise form disclosed above or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

Any element in a claim that does not explicitly state “means for” performing a specified function or “step for” performing a specified function is not to be interpreted as a “means” or “step” clause as specified in 35 U.S.C. § 112(f). In particular, any use of “step of” in the claims herein is not intended to invoke the provisions of 35 U.S. C. § 112(f).

All of the above patents and applications and other references, including any that may be listed in accompanying filing papers, are incorporated herein by reference. Aspects of the invention can be modified, if necessary, to employ the systems, functions, and concepts of the various references described above to provide yet further embodiments of the invention.

Changes can be made to the invention in light of the above “Detailed Description. ” While the above description details certain embodiments of the invention and describes the best mode contemplated, no matter how detailed the above appears in text, the invention can be practiced in many ways. Therefore, implementation details may vary considerably while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

1. A method for securing bins in a lug cart, comprising:
providing a lug cart with a frame supported on wheels and horizontal rails on the frame for supporting bins;
installing a stop mechanism on at least one end of the lug cart, the stop mechanism comprising a locking rod and at least one locking rod bracket;
engaging the stop mechanism without tools to prevent bins from exiting the lug cart; and
disengaging the stop mechanism without tools to allow removal of bins from the lug cart.

2. The method of claim 1, wherein engaging and disengaging the stop mechanism comprises:
lifting the locking rod vertically within the locking rod bracket;
rotating the locking rod to align with a desired slot in the locking rod bracket;
lowering the locking rod into the desired slot.

3. The method of claim 1, further comprising:
installing stop mechanisms on both ends of the lug cart;
independently engaging or disengaging each stop mechanism to allow selective access from either end of the lug cart.

4. The method of claim 1, wherein the stop mechanism is configured to prevent bins from falling when the lug cart is used on a slope or in a marine vessel with turbulence.

5. The method of claim 1, further comprising:
a second locking rod bracket mounted on the frame, wherein the locking rod passes through both the first and second locking rod brackets.

6. The method of claim 1, further comprising:
determining an optimal number of bins to be secured by a single stop mechanism;
designing the locking rod with appropriate length and strength to secure the optimal number of bins.

7. The method of claim 1, wherein the locking rod bracket, comprises:
a body with mounting slots for attachment to the frame;
a central hole for the locking rod to pass through;
at least two slots positioned at different angles for engaging the locking rod.

8. The method of claim 1, further comprising:
securing the locking rod with a retaining mechanism to prevent it from disengaging from the locking rod bracket.

9. The method of claim 7, wherein the retaining mechanism is a nut threaded onto the locking rod.

10. The method of claim 1, further comprising:
using identical and symmetrical upper and lower locking rod brackets,
allowing for interchangeable use on either side or either end of the lug cart.

11. The method of claim 2, wherein rotating the locking rod, comprises turning it through approximately 270 degrees.

12. The method of claim 2, wherein the locking rod has a bent portion engages with the slots in the locking rod bracket.

13. A lug cart, comprising:
a frame supported on wheels and horizontal rails on the frame for supporting bins; and
a stopper on at least one end of the lug cart, the stop mechanism comprising a locking rod and at least one locking rod bracket, wherein a user engages the stopper without tools to prevent bins from exiting the lug cart and disengages the stop mechanism without tools to allow removal of bins from the lug cart.

14. The cart of claim 13, further comprising a second locking rod bracket mounted on the frame, wherein the locking rod passes through both the first and second locking rod brackets.

15. The cart of claim 13, wherein the locking rod bracket further comprises:
a body with mounting slots for attachment to the frame;
a central hole for the locking rod to pass through;
at least two slots positioned at different angles for engaging the locking rod.

16. The cart of claim 13, a retainer to prevent it from disengaging from the locking rod bracket.

17. The cart of claim 13, wherein the retainer is a nut threaded onto the locking rod.

18. The cart of claim 13, further comprising identical and symmetrical upper and lower locking rod brackets, allowing for interchangeable use on either side or either end of the lug cart.

19. The cart of claim 13, wherein the locking rod is turned through approximately 270 degrees.
